(19) United States
(12) Patent Application Publication
(10) Pub. No.: US 2018/0225086 A1
(43) Pub. Date: Aug. 9, 2018

(54) Audio Control of Voice-Activated Devices

(71) Applicants: Adam Scott Hollander, Austin, TX (US); Alan Roy Hollander, Austin, TX (US)

(72) Inventors: Adam Scott Hollander, Austin, TX (US); Alan Roy Hollander, Austin, TX (US)

(21) Appl. No.: 15/425,672

(22) Filed: Feb. 6, 2017

(51) Int. Cl. G06F 3/16; G10L 15/32

(52) U.S. Cl. CPC G06F 3/167; G10L 15/265; G10L 15/32

(57) ABSTRACT

The present invention relates to a system consisting of an electronic device that includes a speaker (a “speaker device”) which is connected to the Internet and can play speech using data received by the speaker device, and an application hosted on a server that enables speech data to be sent to the speaker device, such that when the speaker device is placed in audio proximity to a voice-activated device, the speaker device is capable of playing speech that is audible to the voice-activated device.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

The present invention relates to a system that enables a user to remotely control voice-activated devices, such as Amazon Echo sold by Amazon.com, Inc. or Google Home sold by Google Inc. Voice-activated devices detect speech, send the speech data via the Internet to a server that uses speech recognition technology to process the speech data, and then the server responds by either initiating an action in response, such as playing music through the voice-activated device's speaker or sending a command, such as to a home automation device, or by providing information via a voice response through the voice-activated device's speaker. The system comprises a mobile device or computer that is used to transmit either speech data, or text that can be converted into speech, via the Internet, to a device (the “speaker device”) which plays the speech in audio proximity to a voice-activated device in order to remotely communicate using speech with the voice-activated device.

There is a need to be able to remotely control voice-activated devices for various purposes, including control of home devices, such as lighting and thermostats. In response to those needs, vendors of voice-activated devices provide APIs that enable other companies to integrate their products. These APIs, however, are limited to the extent provided by each vendor and generally provide less functionality than direct speech communication that is enabled by voice-activated devices. In addition, there is a cost to develop the software to use the APIs for each different voice-activated device.

### BRIEF SUMMARY OF THE INVENTION

The present invention consists of a system which comprises:
1. An electronic device (the “speaker device”) that is connected to the Internet, and is capable of playing speech using speech data received via the Internet using readily available components, such as:
   a. a Wi-Fi chip to enable connection to the Internet,
   b. a circuit board to process and control operations,
   c. power components such as a battery and/or plug, and
   d. a speaker.
2. An application hosted on a server connected to the Internet that enables speech data to be:
   a. created, recorded, stored, and sent to the speaker device upon a user initiated event or schedule, or
   b. transmitted in real-time and streamed to the speaker device, and
3. A mobile app or browser interface that communicates with the application via the Internet and enables a user to create, record, and store speech data using a microphone to record speech or typing text, and to control when the application transmits speech data to the speaker device,
   such that when the speaker device is placed in proximity to a voice-activated device, the speaker device is capable of playing speech that is audible to the voice-activated device.

The system may also include a web service that enables communication with the application by third-party applications.

The present invention eliminates the need to develop software applications that use APIs to interact with voice-activated devices as described above and is not limited by the APIs, if any, provided by the vendors of voice-activated devices.

### DETAILED DESCRIPTION OF THE INVENTION

In the preferred embodiment of the invention there is a system consisting of:
1. An electronic device (the “speaker device”) that is connected to the Internet, and is capable of playing speech received via the Internet using readily available components, such as:
   a. a Wi-Fi chip to enable connection to the Internet,
   b. a circuit board to process and control operations,
   c. power components such as a battery and/or plug, and
   d. a speaker.
2. An application hosted on a server connected to the Internet that enables speech data to be transmitted to the speaker device that is
   a. recorded and stored by a user who speaks into the microphone of a mobile device or computer,
   b. uploaded as speech data to the application, or
   c. uploaded to the application as text files that are converted to speech by the application, and
3. A mobile app or browser interface that communicates with the application via the Internet,
   such that when the speaker device is placed in proximity to a voice-activated device, the speaker device is capable of playing speech that is audible to the voice-activated device.

The application may enable various methods for a user to select speech commands to be sent to the speaker device, such as selecting such commands by name or number.

The application may enable speech commands to be sent to the speaker device on a schedule set by a user.

A web service may be provided to enable third-party applications to communicate with the application instead of using a mobile app or a web browser.

Having thus described an inventive concept and embodiments for practicing such concept, it will be appreciated that the embodiments discussed herein are presented by way of example only and are not intended as limiting. Various alterations thereto and other embodiments will readily occur to those skilled in the art and it is intended that they be suggested by this disclosure. Moreover, although some of the examples presented herein involve specific combinations of methods, acts, or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any means, known now or later developed, for performing the recited function. The invention is thus limited only as required by the following claims and equivalents thereto.

The claims for the invention are:

1. A system consisting of an electronic device that includes a speaker and is connected to the Internet and can play speech using speech data received by said device, an application hosted on a server connected to the Internet that enables speech data to be sent to said device, and a mobile app or browser interface that communicates with said application via the Internet to enable a user to create and control speech commands, such that when said device is placed in audio proximity to a voice-activated device, said device is capable of playing speech commands that are audible to the voice-activated device.

2. The system described in claim 1 where said application enables a user to speak into a mobile device or computer and plays the speech in real-time as streaming audio data to said speaker device.

3. The system described in claim 1 where said application enables a user to upload speech files to be stored and sent as speech data to said speaker device upon user initiated events.

4. The system described in claim 1 where said application enables a user to type text that can stored and sent as speech data to the speaker device.

5. The system described in claims 1-4 where said application enables the speech data to be sent to said speaker device on a schedule set by a user.
